(19) United States
(12) Patent Application Publication
(10) Pub. No.: US 2025/0103930 A1
(43) Pub. Date: Mar. 27, 2025

(54) SPLITTING INTEGRATORS FOR FAST SAMPLING FROM DIFFUSION GENERATIVE MODELS

(71) Applicant: Robert Bosch GmbH, Stuttgart (DE)

(72) Inventors: Kushagra Pandey, Irvine, CA (US); Maja Rudolph, Madison, WI (US)

(21) Appl. No.: 18/471,744

(22) Filed: Sep. 21, 2023

(51) Int. Cl. G06N 7/08; G06N 20/00

(52) U.S. Cl. CPC G06N 7/08; G06N 20/00

(57) ABSTRACT

Splitting integrators are provided for fast sampling from a diffusion generative model. A stochastic differential equation (SDE) for the diffusion generative model is split into multiple terms, the multiple terms including deterministic components and random components. Each of the multiple terms is solved to perform a time-reversed noise process using a splitting integrator such that each of the multiple terms is solved separately. Alternating is performed between taking integration steps according to each of the multiple terms. The solving is repeated a desired quantity of steps to complete the time-reversed noise process.

### TECHNICAL FIELD

Aspects of the disclosure relate to splitting integrators for fast sampling from diffusion generative models.

### BACKGROUND

A stochastic differential equation (SDE) is a mathematical model that describes the evolution of a system that is subject to randomness or uncertainty. In an SDE, the evolution of the system is described by a differential equation that involves a random term, often represented by a Brownian motion or a more general stochastic process. An SDE may be used to capture the random fluctuations of a system that cannot be predicted with certainty. For example, the movement of a particle in a fluid, the price of a stock, or the spread of a disease can all be modeled using SDEs.

### SUMMARY

In one or more illustrative examples, a method is performed for using splitting integrators for fast sampling from a diffusion generative model. A stochastic differential equation (SDE) for the diffusion generative model is split into multiple terms, the multiple terms including deterministic components and random components. Each of the multiple terms is solved to perform a time-reversed noise process using a splitting integrator such that each of the multiple terms is solved separately. Alternating is performed between taking integration steps according to each of the multiple terms. The solving is repeated a desired quantity of steps to complete the time-reversed noise process.

In one or more illustrative examples, a system for using splitting integrators for fast sampling from a diffusion generative model, includes one or more computing devices programmed to split a stochastic differential equation (SDE) for the diffusion generative model into multiple terms, the multiple terms including deterministic components and random components; solve each of the multiple terms to perform a time-reversed noise process using a splitting integrator such that each of the multiple terms is solved separately; alternate between taking integration steps according to each of the multiple terms; and repeat the solving a desired quantity of steps to complete the time-reversed noise process.

In one or more illustrative examples, a non-transitory computer-readable medium includes instructions for fast sampling from a diffusion generative model that, when executed by one or more computing devices, cause the computing devices to perform operations including to split a stochastic differential equation (SDE) for the diffusion generative model into multiple terms, the multiple terms include a deterministic position update component [symbol] , a deterministic momentum space update component [symbol] , and a Ohrnstein-Uhlenbeck component [symbol] ; solve each of the multiple terms to perform a time-reversed noise process using a splitting integrator such that each of the multiple terms is solved separately; alternate between taking integration steps according to each of the multiple terms; repeat the solving a desired quantity of steps to complete the time-reversed noise process; and display a generated result of the time-reversed noise process.

### BRIEF DESCRIPTION OF THE DRAWINGS

FIG. 1 illustrates an example process for using splitting integrators for fast sampling from diffusion generative models; and

FIG. 2 illustrates an example computing device for performing the process of FIG. 1 for using splitting integrators for fast sampling from diffusion generative models.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Diffusion models are a class of explicit-likelihood-based generative models that have achieved state-of-the-art results in image generation, video synthesis, 3D shape generation, and related vision tasks. Diffusion models employ a forward stochastic process to add noise to data incrementally, transforming the data-generating distribution to a tractable prior distribution that enables sampling. Subsequently, a learnable reverse process transforms the prior distribution back to the data distribution using a parametric estimator of the gradient field of the log probability density of the data (sometimes referred to as a score).

While it is common to perform diffusion in the data space, recent work has shown that augmenting the state space with auxiliary variables and performing diffusion in the combined space can improve overall sample quality over non-augmented diffusion models. However, sampling in augmented diffusion models still remains expensive since most advances in speeding up diffusion model sampling have focused on non-augmented diffusion models. Moreover, some preliminary work on designing fast samplers for augmented diffusion models relies extensively on special score network parameterizations for good sample quality and does not exploit the coupling between the data and the auxiliary variables.

SDEs are often written in the form:

$$d X ( t ) = f ( X ( t ) , t ) dt + g ( X ( t ) , t ) d W ( t )$$

where:
X(t) is the state of the system at time t;
f(X(t), t) is the deterministic drift term, which describes the rate at which the system changes in a predicable way;
g(X(t), t) is the stochastic diffusion term, which describes the random fluctuations of the system; and
dW(t) is a Wiener process, which is a continuous-time stochastic process that represents the random fluctuations of the system.

In such SDE-based formulations of these models, a SDE is used to add noise to the data until it is transformed into Gaussian noise. To generate a realistic data sample from Gaussian noise, the noise process is reversed by solving another SDE numerically. However, this process is computationally expensive because it requires evaluating the score function at each step, and the number of integration steps can affect the performance of the diffusion model. In existing approaches, numerical SDE solvers used for diffusion models are either very expensive (e.g., meaning they run many steps) or they are inaccurate (e.g., meaning fewer steps lead to worse approximations).

The disclosed approach develops an integration scheme that achieves better results with fewer integration steps. This approach provides a novel SDE integration scheme for diffusion models that enables efficient and accurate image generation and related vision tasks even under a limited budget of score function evaluations.

The scheme splits the SDE into multiple terms, allowing for separate updates and alternating integration steps to improve computational efficiency and performance. Referred to herein as a splitting integrator, each SDE is split into two or more terms, where each term is updated separately. A final splitting integrator alternates between taking an integration step according to each of the terms. Different splitting schemes and different orderings of the terms may be used for taking the integration steps. In some examples, the SDE is split into three terms. In some examples, an Ornstein-Uhlenbeck (OU) process is used, with a term corresponding to the position variables and a term corresponding to the momentum variables. In some examples, Brownian motion is used instead of the OU process.

The approach introduces optional hyperparameters to control the order and step-size of the integration steps, enabling further optimizations and improved results. These hyperparameters may be used to control in which order and with which step-size the integration steps corresponding to the different splitting terms are taken. Optimizing these hyperparameters may leads to further improvements. Experimentally, with a fixed budget of fifty score function evaluations such an approach achieves best diffusion model performance.

A key difference between before and after the approach is the ability to achieve state-of-the-art results with a restricted number of solver steps, making the diffusion model more practical and accessible for a wider range of applications, especially under constrained resources.

Examples of these techniques are discussed in terms of deterministic and stochastic splitting integrators for fast sampling from augmented diffusion models. More specifically, many examples herein relate to speeding up deterministic and stochastic sampling from the Phase-Space Langevin Diffusion (PSLD) model. This is proposed due to the PSLD model's strong empirical performance on standard image synthesis benchmarks. Though this disclosure is largely focused on augmented diffusion models, the techniques presented can also be adapted for non-augmented diffusions.

Consider the following forward process SDE for converting data zₜ∈ [symbol] to noise,

$$d {z}_{t} = f ( {z}_{t} , t ) dt + {G}_{t} {dw}_{t} , t ∈ [ 0 , T ] ,$$

with:
continuous time variable t∈[0, T],
standard Wiener process wₜ,
drift coefficient f: [symbol] ×[0,T]→ [symbol] , and
diffusion coefficient G: [0,T]→ [symbol] ×d.

Given this forward process, the corresponding reverse-time diffusion process that generates data from noise can be given by:

$$d {z}_{t} = [ f ( {z}_{t} , t ) - {G}_{\text{?}} {G}_{\text{?}}^{T} {∇}_{{x}_{\text{?}}} log {p}_{t} ( {z}_{t} ) ] dt + {G}_{t} d {\overline{w}}_{t} \qquad ( 1 )$$

$$\text{?} \text{indicates text missing or illegible when filed}$$

Alternatively, data can also be generated using the Probability-Flow ODE:

$$d {z}_{t} = [ f ( {z}_{\text{?}} , t ) - {G}_{\text{?}} {G}_{\text{?}}^{T} {∇}_{{z}_{\text{?}}} log {p}_{\text{?}} ( {z}_{\text{?}} ) ] dt \qquad ( 2 )$$

$$\text{?} \text{indicates text missing or illegible when filed}$$

Given an estimate of the score ∇zₜ log pₜ(zₜ) of the marginal distribution over zₜ at time t, the reverse SDE can then be simulated to recover the original data samples from noise. In practice, the score is intractable to compute and is approximated using a parametric estimator s_{θ}(zₜ, t), trained using denoising score matching. The forward SDE may asymptotically converge to an equilibrium distribution (e.g., a standard isotropic Gaussian) which can be used as a prior distribution to initialize the reverse SDE. The reverse SDE can then be simulated using numerical solvers to generate samples from the data distribution. Moreover, depending on the space in which diffusion is performed, the class of diffusion processes can be categorized into two broader sub-classes: Non-Augmented Diffusions or Augmented Diffusions.

For non-augmented diffusion models, diffusion is performed in the original data space i.e. zₜ=xₜ∈ [symbol] . One popular choice among non-augmented diffusions is the Variance Preserving (VP)-SDE, which may be computed as follows:

$${dx}_{\text{?}} = \frac{{β}_{t}}{2} {x}_{\text{?}} dt + \sqrt{{β}_{t}} d {w}_{t} \qquad ( 3 )$$

$$\text{?} \text{indicates text missing or illegible when filed}$$

In another example, a re-scaled process may be used which has better conditioned solution trajectories for faster sampling during generation, as follows:

$${dx}_{\text{?}} = \sqrt{2 {\dot{σ}}_{\text{?}} {σ}_{\text{?}}} d {w}_{t} \qquad ( 4 )$$

$$\text{?} \text{indicates text missing or illegible when filed}$$

where βₜ, σₜ∈ [symbol] define the noise schedule in their respective diffusion processes.

For augmented diffusion models, the data space is coupled with auxiliary variables, and diffusion is performed in the joint space, i.e., zₜ=[xₜ, mₜ]^{T}∈ [symbol] , where xₜ, mₜ∈ [symbol] . In the case of Phase-Space Langevin Diffusion (PSLD):

$$d ( \begin{matrix}{x}_{\text{?}} \\ {m}_{\text{?}}\end{matrix} ) = ( \frac{β}{2} ( \begin{matrix}- Γ & {M}^{- 1} \\ - 1 & - v\end{matrix} ) ⊗ {I}_{d} ) ( \begin{matrix}{x}_{\text{?}} \\ {m}_{\text{?}}\end{matrix} ) dt + ( ( \begin{matrix}\sqrt{Γβ} & 0 \\ 0 & \sqrt{M v β}\end{matrix} ) ⊗ {I}_{d} ) d {w}_{t} \qquad ( 5 )$$

$$\text{?} \text{indicates text missing or illegible when filed}$$

where {β, Γ, v, M−1}∈ [symbol] are the SDE hyperparameters. Similarly, Critically Damped Langevin Diffusion (CLD) may be used, which is a special case of PSLD with Γ=0. Interestingly, augmented diffusion models have been shown to exhibit better sample quality with a faster generation process and better likelihood estimation over their non-augmented counterparts.

In an example, splitting of integration for faster sampling is now described in the context of a PSLD model with the following forward diffusion process:

$$d ( \begin{matrix}{x}_{\text{?}} \\ {m}_{\text{?}}\end{matrix} ) = ( \frac{β}{2} ( \begin{matrix}- Γ & {M}^{- 1} \\ - 1 & - v\end{matrix} ) ⊗ {I}_{d} ) ( \begin{matrix}{x}_{\text{?}} \\ {m}_{\text{?}}\end{matrix} ) dt + ( ( \begin{matrix}\sqrt{Γβ} & 0 \\ 0 & \sqrt{M v β}\end{matrix} ) ⊗ {I}_{d} ) d {w}_{t} \qquad ( 6 )$$

$$\text{?} \text{indicates text missing or illegible when filed}$$

where xₜ, mₜ∈ [symbol] are the data and the auxiliary (or momentum) variables, respectively. Consequently, the probability flow ODE for PSLD is given by:

$$( \begin{matrix}d {\overline{x}}_{\text{?}} \\ d {\overline{m}}_{\text{?}}\end{matrix} ) = \frac{β}{2} ( \begin{matrix}Γ {\overline{x}}_{t} - {M}^{- 1} {\overline{m}}_{t} + Γ {s}_{θ}^{x} ( {\overline{z}}_{t} , t ) \\ {\overline{x}}_{\text{?}} + ν {\overline{m}}_{\text{?}} + M ν {s}_{θ}^{m} ( {\overline{z}}_{t} , t )\end{matrix} ) dt , t ∈ [ 0 , T ] \qquad ( 7 )$$

$$\text{?} \text{indicates text missing or illegible when filed}$$

where:
x̅ₜ=x_{T-t},
m̅ₜ=m_{T-t},
z̅ₜ=[x̅ₜ, m̅ₜ]^{T}, and
s_{θ}(zₜ, t)=[s_{θ}^{x}(zₜ, t), s_{θ}^{m}(zₜ, t)]^{T} is a parametric approximation of the ground truth score ∇_{z}, log pₜ(zₜ).

Similarly the reverse SDE for PSLD can be specified as:

$$d ( \begin{matrix}{\overline{x}}_{\text{?}} \\ {\overline{m}}_{\text{?}}\end{matrix} ) = \frac{β}{2} ( \begin{matrix}Γ {\overline{x}}_{\text{?}} - {M}^{- 1} {\overline{m}}_{\text{?}} + Γ {s}_{θ}^{x} ( {\overline{z}}_{\text{?}} , t ) \\ {\overline{x}}_{\text{?}} + ν {\overline{m}}_{\text{?}} + M \text{?} {s}_{θ}^{m} ( {\overline{z}}_{\text{?}} , t )\end{matrix} ) dt , t ∈ [ 0 , T ] \qquad ( 8 )$$

$$\text{?} \text{indicates text missing or illegible when filed}$$

The following may be assumed as we assume the score network parameterization:

$${s}_{θ} ( {z}_{\text{?}} , t ) = {C}_{s} ( t ) {z}_{t} + {C}_{o} ( t ) {ϵ}_{θ} ( {C}_{\text{?}} ( t ) {z}_{\text{?}} , {C}_{n} ( t ) ) \qquad ( 9 )$$

$$\text{?} \text{indicates text missing or illegible when filed}$$

This score network parameterization may be adapted as follows for use here:

$${C}_{\text{?}} ( t ) = 0 , {C}_{o} ( t ) = - {L}_{\text{?}}^{- T} , {C}_{\text{?}} ( t ) = {I}_{2 d} , {C}_{n} ( t ) = t . \qquad ( 10 )$$

$$\text{?} \text{indicates text missing or illegible when filed}$$

where Lₜ^{-T} is the transposed-inverse of the Cholesky decomposition of the covariance matrix Σₜ of the perturbation kernel in PSLD. Lastly pre-trained PSLD models for may be used to compare different baselines.

Referring more specifically to the splitting of integrators, a discussion of splitting integrators for Hamiltonian systems is provided. Consider a Hamiltonian system of the form:

$$( \begin{matrix}{dx}_{\text{?}} \\ d {m}_{\text{?}}\end{matrix} ) = J ∇ H dt \qquad ( 11 )$$

$$where :$$

$$∇ H = ( \begin{matrix}∇ U ( {x}_{\text{?}} ) \\ {M}^{- 1} {m}_{\text{?}}\end{matrix} ) and$$

$$J = ( \begin{matrix}0 & 1 \\ - 1 & 0\end{matrix} )$$

$$\text{?} \text{indicates text missing or illegible when filed}$$

Furthermore, two splittings of the Hamiltonian H may be defined as, H₁ and H₂ such that:

$$J ∇ H = J ∇ {H}_{1} + J ∇ {H}_{2} \qquad ( 12 )$$

It then follows from the BCH lemma that:

$$exp ( - t {ℒ}_{H} ) \approx exp ( - t {ℒ}_{{H}_{1}} ) exp ( - t {ℒ}_{{H}_{2}} ) \qquad ( 13 )$$

where exp( ) denotes the operator exponential. Intuitively, the above result implies that the solution of Eqn. 11 can be approximated as the composition of the solutions obtained by (numerically) solving the two splitting components in isolation.

Splitting integrators may be used in the design of symplectic numerical solvers for molecular dynamics systems which preserve a certain geometric property of the underlying physical system. An example splitting integrator for Hamiltonian systems is the Verlet method (commonly known as the LeapFrog integrator in HMC methods). More specifically, under the (Velocity) Verlet scheme, the following splitting is proposed:

$$( \begin{matrix}{dx}_{t} \\ {dm}_{t}\end{matrix} ) = \frac{1}{2} ( \begin{matrix}0 \\ - ∇ U ( {x}_{i} )\end{matrix} ) + ( \begin{matrix}{M}^{- 1} {m}_{t} \\ 0\end{matrix} ) + \frac{1}{2} ( \begin{matrix}0 \\ - ∇ U ( {x}_{t} )\end{matrix} ) \qquad ( 14 )$$

The three parts may be individually solved using the Euler method and the solutions may be composed to reach a final solution. More specifically, the update rules for the Velocity-Verlet scheme, given a step size h and the starting point (xₜ, mₜ), are as follows:

$${m}_{t + h / 2} = {m}_{t} - \frac{h}{2} ∇ U ( {x}_{t} ) \qquad ( 15 )$$

$${x}_{t + h} = {x}_{t} + {hM}^{- 1} {m}_{t + h / 2} \qquad ( 16 )$$

$${m}_{t + h} = {m}_{t + h / 2} - \frac{h}{2} ∇ U ( {x}_{t + h} ) \qquad ( 17 )$$

The resulting updated solution (xₜ₊ₕ, mₜ₊ₕ) can then be used for subsequent updates. It can be shown that the local error for the Velocity Verlet method is O(h²) in the stepsize h in both the position and the momentum space. Significantly, the aforementioned techniques may be applied to splitting integrators for faster deterministic and stochastic sampling in PSLD.

Regarding deterministic splitting of integrators for PSLD, for the probability flow ODE in Eqn. 7, the updates in the position and the momentum space may be split as follows:

$$( \begin{matrix}d {\overline{x}}_{t} \\ d {\overline{m}}_{t}\end{matrix} ) = {\underbrace{\frac{β}{2} ( \begin{matrix}Γ {\overline{x}}_{t} - {M}^{- 1} {\overline{m}}_{t} + Γ {s}_{θ}^{x} ( {\overline{z}}_{t} , t ) \\ 0\end{matrix} )}}_{{ℒ}_{x}} dt + {\underbrace{\frac{β}{2} ( \begin{matrix}0 \\ {\overline{x}}_{t} + v {\overline{m}}_{t} + {Mvs}_{θ}^{m} ( {\overline{z}}_{t} , t )\end{matrix} )}}_{{ℒ}_{m}} dt \qquad ( 18 )$$

For the rest of the discussion, the numerical update for each split may be approximated using a simple Euler-based update. Furthermore, based on the splitting components in the data and the momentum space, various samplers may be used, such as a Naive Symplectic Euler (NSE) or a Naive Velocity Verlet (NVV).

Regarding the NSE approach, in this scheme, for a given step size h, the solutions to the splitting pieces [symbol] and [symbol] are combined as:

$$exp ( - h ℒ ) \approx exp ( - h {ℒ}_{m} ) exp ( - h {ℒ}_{x} ) \qquad ( 19 )$$

Consequently, one numerical update step for this integrator can be defined as:

$${\overline{m}}_{t + h} = {\overline{m}}_{t} + \frac{h β}{2} [ {\overline{x}}_{t} + v {\overline{m}}_{t} + {Mvs}_{θ}^{m} ( {\overline{x}}_{t} , {\overline{m}}_{t} , T - t ) ] \qquad ( 20 )$$

$${\overline{x}}_{t + h} = {\overline{x}}_{t} + \frac{h β}{2} [ Γ {\overline{x}}_{t} - {M}^{- 1} {\overline{m}}_{t + h} + Γ {s}_{θ}^{x} ( {\overline{x}}_{t} , {\overline{m}}_{t + h} , T - t ) ] \qquad ( 21 )$$

Regarding the NVV approach, in this scheme contrary to the NSE scheme, half-steps are introduced when combining the solutions to the splitting pieces [symbol] and [symbol] as follows:

$$exp ( - h ℒ ) \approx exp ( - \frac{h}{2} {ℒ}_{m} ) exp ( - h {ℒ}_{x} ) exp ( - \frac{h}{2} {ℒ}_{m} ) \qquad ( 22 )$$

Consequently, one numerical update step for this integrator can be defined as:

$${\overline{m}}_{t + h / 2} = {\overline{m}}_{t} = \frac{h β}{4} [ {\overline{x}}_{t} + v {\overline{m}}_{t} + {Mvs}_{θ}^{m} ( {\overline{x}}_{t} , {\overline{m}}_{t} , T - t ) ] \qquad ( 23 )$$

$${\overline{x}}_{t + h} = {\overline{x}}_{t} + \frac{h β}{2} [ Γ {\overline{x}}_{t} - {M}^{- 1} {\overline{m}}_{t + h / 2} + Γ {s}_{θ}^{x} ( {\overline{x}}_{t} , {\overline{m}}_{t + h / 2} , T - t ) ] \qquad ( 24 )$$

$${\overline{m}}_{t + h} = {\overline{m}}_{t + h / 2} + \frac{h β}{4} [ {\overline{x}}_{t + h} + v {\overline{m}}_{t + h / 2} + {Mvs}_{θ}^{m} ( {\overline{x}}_{t + h} , {\overline{m}}_{t + h / 2} , T - t ) ] \qquad ( 25 )$$

While the NSE and NVV samplers perform well in practice, their respective numerical schemes may be sub-optimal. Based on local error analysis, several modifications may be made to the update steps in the NSE and NVV samplers. These resulting schemes may be referred to as the Adjusted Symplectic Euler (ASE) and Adjusted Velocity Verlet (AVV) respectively, for which the update steps are specified as follows.

Regarding the ASE approach, the numerical update step for this scheme are as follows, with the final term changed from the NSE scheme:

$${\overline{m}}_{t + h} = {\overline{m}}_{t} + \frac{h β}{2} [ {\overline{x}}_{t} + v {\overline{m}}_{t} + {Mvs}_{θ}^{m} ( {\overline{x}}_{t} , {\overline{m}}_{t} , T - t ) ] \qquad ( 26 )$$

$${\overline{x}}_{t + h} = {\overline{x}}_{t} + \frac{h β}{2} [ Γ {\overline{x}}_{t} - {M}^{- 1} {\overline{m}}_{t + h} + Γ {s}_{θ}^{x} ( {\overline{x}}_{t} , {\overline{m}}_{t} , T - t ) ] \qquad ( 27 )$$

Regarding the AVV approach, the numerical updates for this scheme are as follows, here similarly with certain terms changed from the NVV scheme:

$${\overline{m}}_{t + h / 2} = {\overline{m}}_{t} + \frac{h β}{4} [ {\overline{x}}_{t} + v {\overline{m}}_{t} + {Mvs}_{θ}^{m} ( {\overline{x}}_{t} , {\overline{m}}_{t} , T - t ) ] \qquad ( 28 )$$

$${\overline{x}}_{t + h} = {\overline{x}}_{t} + \frac{h β}{2} [ Γ {\overline{x}}_{t} - {M}^{- 1} {\overline{m}}_{t + h / 2} + Γ {s}_{θ}^{x} ( {\overline{x}}_{t} , {\overline{m}}_{t} , T - t ) ] \qquad ( 29 )$$

$${\overline{m}}_{t + h} = {\overline{m}}_{t + h / 2} + \frac{h β}{4} [ {\overline{x}}_{t + h} + v {\overline{m}}_{t + h / 2} + {Mvs}_{θ}^{m} ( {\overline{x}}_{t + h} , {\overline{m}}_{t + h / 2} , T - ( t + h ) ) ] \qquad ( 30 )$$

Empirically, it may be found that the AVV and ASE schemes perform much better than their naive counterparts when the number of reverse diffusion steps is small.

With these schemes outlined, stochastic splitting integrators for PSLD may now be discussed. Similar to the discussion in deterministic splitting integrators, for the reverse process SDE in Eqn. 8, the deterministic updates in the position and the momentum space from the stochastic updates may be separated as follows:

$$( \begin{matrix}d {\overline{x}}_{t} \\ d {\overline{m}}_{t}\end{matrix} ) = {\underbrace{\frac{β}{2} ( \begin{matrix}2 Γ {\overline{x}}_{t} - {M}^{- 1} {\overline{m}}_{t} + 2 Γ {s}_{θ}^{x} ( {\overline{z}}_{t} , t ) \\ 0\end{matrix} )}}_{A} dt + {\underbrace{( \begin{matrix}- \frac{βΓ}{2} {\overline{x}}_{t} dt + \sqrt{βΓ} d {\overline{w}}_{t} \\ - \frac{β v}{2} {\overline{m}}_{t} dt + \sqrt{Mv β} d {\overline{w}}_{t}\end{matrix} )}}_{O} + {\underbrace{\frac{β}{2} ( \begin{matrix}0 \\ {\overline{x}}_{t} + 2 v {\overline{m}}_{t} + 2 {Mvs}_{θ}^{m} ( {\overline{z}}_{t} , t )\end{matrix} )}}_{B} dt$$

While the solution of the deterministic components [symbol] and [symbol] can be approximated using any numerical scheme like Euler, the solution of the Ohrnstein-Uhlenbeck component [symbol] can be computed in closed form and is given by the following update step:

$${\overline{x}}_{t + h} = exp ( \frac{- h βΓ}{2} ) {\overline{x}}_{t} + \sqrt{1 - exp ( - h β Γ )} {ϵ}_{x} , {ϵ}_{x} \sim 𝒩 ( {0}_{d} , {I}_{d} ) \qquad ( 31 )$$

$${\overline{m}}_{t + h} = exp ( \frac{- h β v}{2} ) {\overline{m}}_{t} + \sqrt{M} \sqrt{1 - exp ( - h β v )} {ϵ}_{m} , {ϵ}_{m} \sim 𝒩 ( {0}_{d} , {I}_{d} ) \qquad ( 32 )$$

Therefore, based on the deterministic and stochastic splitting components for the PSLD SDE, the following sampler is proposed:

$$exp ( - h ℒ ) \approx exp ( - h {ℒ}_{O} ) exp ( - h {ℒ}_{B} ) exp ( - h {ℒ}_{A} ) \qquad ( 33 )$$

Consequently, one numerical update step for this integrator can be defined as:

$${\overline{x}}_{t + h} = exp ( \frac{- h β Γ}{2} ) {\overline{x}}_{t} + \sqrt{1 - exp ( - h β Γ )} {ϵ}_{x} \qquad ( 34 )$$

$${\overline{m}}_{t + h} = exp ( \frac{- h β v}{2} ) {\overline{m}}_{t} + \sqrt{M} \sqrt{1 - exp ( - h β v )} {ϵ}_{m} \qquad ( 35 )$$

$${\overline{m}}_{t + h} = {\overline{m}}_{t + h} + \frac{h β}{2} [ {\overline{x}}_{t + h} + 2 v {\overline{m}}_{t + h} + 2 {Mvs}_{θ}^{m} ( {\overline{x}}_{t + h} , {\overline{m}}_{t + h} , T - t ) ] \qquad ( 36 )$$

$${\overline{x}}_{t + h} = {\overline{x}}_{t + h} + \frac{h β}{2} [ 2 Γ {\overline{x}}_{t + h} - {M}^{- 1} {\overline{m}}_{t + h} + 2 Γ {s}_{θ}^{x} ( {\overline{x}}_{t + h} , {\overline{m}}_{t + h} , T - t ) ] \qquad ( 37 )$$

Regarding varying the amount of stochasticity, it may be found that found that varying the amount of stochasticity injected in the position space update for [symbol] affects the sample quality significantly. Therefore, a parameter λₛ may be introduced which controls the amount of stochasticity injected in the position space update for [symbol] . The modified update step can be defined as:

$${\overline{x}}_{t + h} = exp ( \frac{- h βΓ}{2} ) {\overline{x}}_{t} + \sqrt{1 - exp ( - t {λ}_{s} βΓ )} {ϵ}_{x} , {ϵ}_{x} \sim 𝒩 ( {0}_{d} , {I}_{d} ) \qquad ( 38 )$$

It may be found that adding a similar parameter in the momentum space update for [symbol] affects sample quality negatively. Therefore, the shown approach only controls the amount of noise injected in the position space. A similar observation can be made that the amount of noise injected in the stochastic update is controlled through a parameter S_{churn}. Therefore, the modified update rules for the Adjusted OBA sampler can be specified as:

$${\overline{x}}_{t + h} = exp ( \frac{- h βΓ}{2} ) {\overline{x}}_{t} + \sqrt{1 - exp ( - t {λ}_{s} βΓ )} {ϵ}_{x} \qquad ( 39 )$$

$${\overline{m}}_{t + h} = exp ( \frac{- h β v}{2} ) {\overline{m}}_{t} + \sqrt{M} \sqrt{1 - exp ( - h β v )} {ϵ}_{m} \qquad ( 40 )$$

$${\overline{m}}_{t + h} = {\overline{m}}_{t + h} + \frac{h β}{2} [ {\overline{x}}_{t + h} + 2 v {\overline{m}}_{t + h} + 2 {Mvs}_{θ}^{m} ( {\overline{x}}_{t + h} , {\overline{m}}_{t + h} , T - t ) ] \qquad ( 41 )$$

$${\overline{x}}_{t + h} = {\overline{x}}_{t + h} + \frac{h β}{2} [ 2 Γ {\overline{x}}_{t + h} - {M}^{- 1} {\overline{m}}_{t + h} + 2 Γ {s}_{θ}^{x} ( {\overline{x}}_{t + h} , {\overline{m}}_{t + h} , T - t ) ] \qquad ( 42 )$$

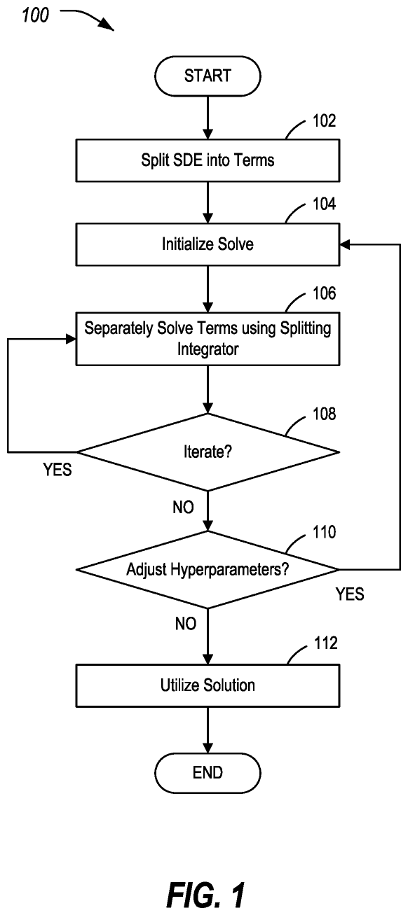

FIG. 1 illustrates a method 100 for using splitting integrators for fast sampling from diffusion generative models. This method 100 may be used for improving the performance of diffusion models, enabling more efficient image generation, video synthesis, 3D shape generation, and related vision tasks. The method 100 may include the following operations.

At operation 102, the SDE is split into multiple terms. The multiple terms include two or more terms, and different splitting schemes may be used. In some examples discussed herein, the SDE is split into three terms: a deterministic position update component [symbol] , a deterministic momentum space update component [symbol] , and a Ohrnstein-Uhlenbeck component [symbol] . In some examples, Brownian motion is used instead of the OU process. By splitting into multiple terms, split integrators may be used for faster deterministic and stochastic sampling.

At operation 104, a solve operation is initialized. For example, a sample from Gaussian noise can then be transformed into a realistic data sample by computing a time-reversed noise process. To this end, a random image in a latent space may be generated. Additionally, hyperparameters may be set that control in which order and with which step-size the integration steps corresponding to the different splitting terms are taken. In another example, a parameter λₛ may be set which controls the amount of stochasticity injected in the position space update for [symbol] .

At operation 106, each term is solved separately using a splitting integrator. Example numerical updater rules are discussed in detail above. As noted herein, it is alternated between taking integration steps according to each term. Different orderings of the terms may be used for performing successive integration steps. In some examples, the ordering is defined by hyperparameters as noted above.

At operation 108, it is determined whether the desired quantity of steps have been performed. If so, control proceeds to operation 110. If not, control returns to operation 106 to perform another cycle.

At operation 110, hyperparameters are optionally optimized for the best performance. For example, the hyperparameters may be adjusted that control in which order and with which step-size the integration steps corresponding to the different splitting terms are taken. In another example, the parameter λₛ may be updated to change the amount of stochasticity injected in the position space update for [symbol] . Optimizing the hyperparameters may leads to further improvements. If the hyperparameters are optimized, control returns to operation 104. Otherwise, control proceeds to operation 114.

At operation 112, the solution is utilized. For example, the image that is generated maybe be displayed or otherwise used, a video that is generated may be shown, a 3D shape that is generated may be displayed, printed, or otherwise used.

Thus, an integration scheme for SDE-based diffusion models is provided, enabling faster and more accurate image generation and related vision tasks. The splitting integrator approach splits the SDE into multiple terms, allowing for separate updates and improved performance. The choices, e.g., between an Ornstein-Uhlenbeck process or Brownian motion provide flexibility and customization. The available hyperparameters further enhance the performance of the invention, allowing for the best diffusion model performance with a fixed budget of, e.g., score function evaluations. In comparison to prior methods, the disclosed approach offers faster and more accurate image generation, as well as improved flexibility and customization. Additionally, the usage of a splitting integrator approach and optimized hyperparameters provide a more robust and reliable method for SDE-based diffusion models, enabling better performance and efficiency.

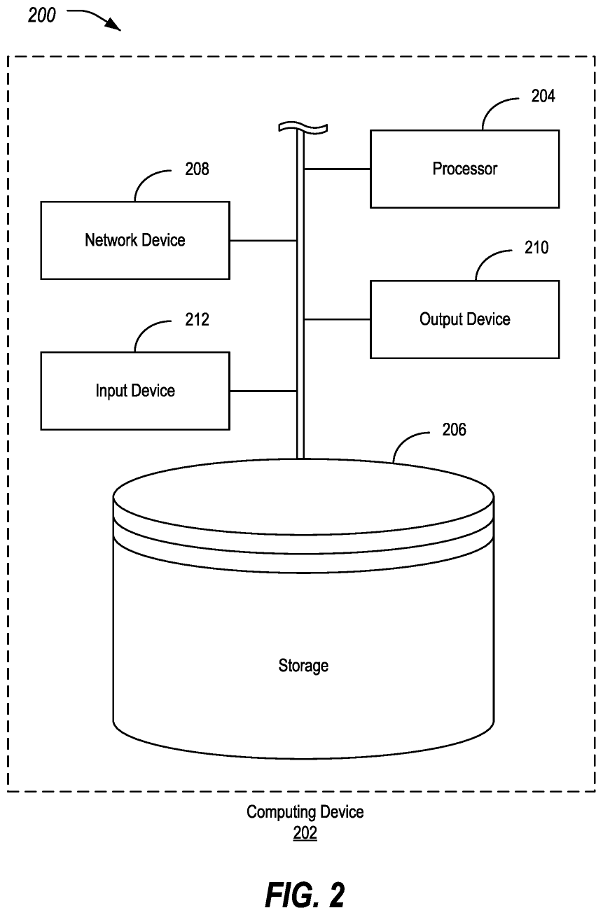

FIG. 2 illustrates an example 200 of a computing device 202 for implementing aspects of the use of splitting integrators for fast sampling from diffusion generative models. Referring to FIG. 2, and with reference to FIG. 1 and the disclosure herein, the process 100 may be performed by examples of such computing devices 202. As shown, the computing device 202 includes a processor 204 that is operatively connected to a storage 206, a network device 208, an output device 210, and an input device 212. It should be noted that this is merely an example, and computing devices 202 with more, fewer, or different components may be used.

The processor 204 may include one or more integrated circuits that implement the functionality of a central processing unit (CPU) and/or graphics processing unit (GPU). In some examples, the processors 204 are a system on a chip (SoC) that integrates the functionality of the CPU and GPU. The SoC may optionally include other components such as, for example, the storage 206 and the network device 208 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 204 executes stored program instructions, such as those of the positioning application 124, that are retrieved from the storage 206. The stored program instructions, accordingly, include software that controls the operation of the processors 204 to perform the operations described herein. The storage 206 may include both non-volatile memory and volatile memory devices. The non-volatile memory includes solid-state memories, such as not and (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 210. The output device 210 may include a graphical or visual display device, such as an electronic display screen, projector, printer, or any other suitable device that reproduces a graphical display. As another example, the output device 210 may include an audio device, such as a loudspeaker or headphone. As yet a further example, the output device 210 may include a tactile device, such as a mechanically raiseable device that may, in an example, be configured to display braille or another physical output that may be touched to provide information to a user.

The input device 212 may include any of various devices that enable the computing device 202 to receive control input from users. Examples of suitable input devices that receive human interface inputs may include keyboards, mice, trackballs, touchscreens, voice input devices, graphics tablets, and the like.

The network devices 208 may each include any of various devices that enable the computing device 202 to send and/or receive data from external devices over networks. Examples of suitable network devices 208 include an Ethernet interface, a Wi-Fi transceiver, a cellular transceiver, or a BLUETOOTH or BLE transceiver, UWB transceiver, or other network adapter or peripheral interconnection device that receives data from another computer or external data storage device, which may be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for using splitting integrators for fast sampling from a diffusion generative model, comprising:
splitting a stochastic differential equation (SDE) for the diffusion generative model into multiple terms, the multiple terms including deterministic components and random components;
solving each of the multiple terms to perform a time-reversed noise process using a splitting integrator such that each of the multiple terms is solved separately;
alternating between taking integration steps according to each of the multiple terms; and
repeating the solving a desired quantity of steps to complete the time-reversed noise process.

2. The method of claim 1, wherein the multiple terms include a deterministic position update component [symbol] , a deterministic momentum space update component [symbol] , and a Ohrnstein-Uhlenbeck component [symbol] .

3. The method of claim 2, further comprising controlling an amount of stochasticity injected in the position space update for [symbol] by varying a parameter λₛ.

4. The method of claim 2, further comprising approximating the solution of the deterministic components [symbol] and [symbol] using a numerical scheme for solving differential equations.

5. The method of claim 4, wherein the numerical scheme is the Euler method.

6. The method of claim 1, wherein the multiple terms include one or more deterministic component terms and a Brownian motion term.

7. The method of claim 1, wherein the diffusion generative model is a Score-based Generative Model (SGM).

8. The method of claim 7, wherein the SGM is a Phase-Space Langevin Diffusion (PSLD) model.

9. The method of claim 1, wherein the diffusion generative model is an image generation model, and the time-reversed noise process produces a generated image.

10. The method of claim 1, wherein the diffusion generative model is an 3D model generation model, and the time-reversed noise process produces a generated 3D model.

11. A system for using splitting integrators for fast sampling from a diffusion generative model, comprising:
one or more computing devices programmed to:
split a stochastic differential equation (SDE) for the diffusion generative model into multiple terms, the multiple terms including deterministic components and random components;
solve each of the multiple terms to perform a time-reversed noise process using a splitting integrator such that each of the multiple terms is solved separately;
alternate between taking integration steps according to each of the multiple terms; and
repeat the solving a desired quantity of steps to complete the time-reversed noise process.

12. The system of claim 11, wherein the multiple terms include a deterministic position update component [symbol] , a deterministic momentum space update component [symbol] , and a Ohrnstein-Uhlenbeck component [symbol] .

13. The system of claim 12, further comprising controlling an amount of stochasticity injected in the position space update for [symbol] by varying a parameter λₛ.

14. The system of claim 12, further comprising approximating the solution of the deterministic components [symbol] and [symbol] using a numerical scheme for solving differential equations.

15. The system of claim 14, wherein the numerical scheme is the Euler method.

16. The system of claim 11, wherein the multiple terms include one or more deterministic component terms and a Brownian motion term.

17. The system of claim 11, wherein the diffusion generative model is a Score-based Generative Model (SGM).

18. The system of claim 17, wherein the SGM is a Phase-Space Langevin Diffusion (PSLD) model.

19. A non-transitory computer-readable medium comprising instructions for fast sampling from a diffusion generative model that, when executed by one or more computing devices, cause the computing devices to perform operations including to:
split a stochastic differential equation (SDE) for the diffusion generative model into multiple terms, the multiple terms include a deterministic position update component [symbol] , a deterministic momentum space update component [symbol] , and a Ohrnstein-Uhlenbeck component [symbol] ;
solve each of the multiple terms to perform a time-reversed noise process using a splitting integrator such that each of the multiple terms is solved separately;
alternate between taking integration steps according to each of the multiple terms;
repeat the solving a desired quantity of steps to complete the time-reversed noise process; and
display a generated result of the time-reversed noise process.

20. The non-transitory computer-readable medium of claim 19, wherein the diffusion generative model is a Phase-Space Langevin Diffusion (PSLD) model.
